(19) United States
(12) Patent Application Publication
(10) Pub. No.: US 2007/0113755 A1
(43) Pub. Date: May 24, 2007

(54) Shaping paste, their use as well as procedure for the production of a ceramic body

(75) Inventors: Ulrich Koops, Rossdorf (DE); Robin Huhn, Rodenbach (DE); Ozlem Weiss, Frankfurt (DE)

Correspondence Address: William C. Gerstenzang;Norris, McLaughlin & Marcus P.A., 18th Floor, 875 Third Avenue, New York, NY, 10022, US

(73) Assignee: HERAEUS KULZER GMBH, Hanau (DE)

(21) Appl. No.: 11/451,136

(22) Filed: Jun. 12, 2006

(30) Foreign Application Priority Data
Jun. 20, 2005 (DE) 10 2005 028 721.2

(51) Int. Cl. B29C 41/16; C09K 3/00

(52) U.S. Cl. 106/35; 264/86

(57) ABSTRACT

A molding paste for use in ceramic molding containing at least one release agent, at least one ion-donating agent, and/or an amphoteric substance has in particular an electrostatically destabilizing effect on ceramic slips.

The invention relates to a composition in the form of a molding paste for use in ceramic molding, and use thereof in ceramic molding methods based on ceramic suspensions.

Very different methods from the prior art may be used for producing ceramic components. These methods may be divided into pressing methods, plastic molding, and casting techniques using ceramic suspensions. The casting techniques are based on the introduction of a stabile ceramic suspension (so-called “slip”) into a porous mold which is usually composed of gypsum or microporous plastic and which withdraws the liquid from the suspension by capillary force, thereby forming a compact particle layer on the mold wall (shard or molded body formation). The so-called “green bodies” obtained must then be sintered for final compression, resulting in up to 30% shrinkage which must be taken into account in the design of the gypsum mold. A major advantage of this method is that it enables the production of even complex parts which have thin walls and asymmetric shapes. The casting method may be automated so that even small batches may be economically produced. Disadvantages and limiting factors are the long times for shard formation, the critical procedure of removing the molded body, and the low durability of the molds, which must be dried for a long period after every molding process and which are thus subjected to high stress.

One technical approach to sizing the mold to the shrinkage rate of the green body and the critical release from the mold was proposed in the field of dental technology in EP 0 241 384, by a method in which the slip is applied in layers with a brush onto a duplicate of the tooth stump made of a specialized gypsum, or in which a cap is formed on the stump by repeated immersion of the stump in the slip, the cap already having its final dimensions. This method is primarily used for producing crown copings. A first firing is then performed at low temperatures while the green body is still on the stump. The slight shrinkage of up to 2% causes the gypsum model to slowly release from the green body. In the first sinter firing which follows, a porous white body is formed from the green body which acquires its final consistency in the last step by glass infiltration. Disadvantages of this process are the long processing times due to duplication of the master model, the layer thickness of the cap which cannot be controlled, and the susceptibility to error resulting from strictly manual processing.

A refinement of the molding from ceramic slips is electrophoretic deposition on a conductive mold. A conductive layer is applied to the mold, and application of direct current voltage causes the charged slip particles in the vicinity to migrate to the mold, where they are deposited (DE 103 32 802 A1, DE 103 46 775 A1, DE 103 39 603 A1). A further measure for producing a uniform layer thickness by dewatering is proposed in DE 101 27 144 B4, in which a hygroscopic layer of a gel, for example, is applied. According to claim 4 of the cited document a voltage may be applied to accelerate the deposition of particles, whereby the molding is likewise based on the principle of electrophoresis. In practice, it has been shown that without the application of direct current voltage this method requires repeated immersion of the mold in the slip, which does not allow the obtained layer thickness to be controlled. This is remedied by subsequently milling down the resulting mold to the desired thickness. A uniform layer thickness is obtained only by the principle of electrophoresis. The disadvantages of electrophoresis are the mandatory requirement for conductivity of the mold upon which deposition is performed; i.e., the gypsum mold must be provided with a conductive layer, or a conductive molding material must be used. In both cases, additional manual process steps are necessary after production of the gypsum mold which prolong the overall process and represent sources of error.

The object is to improve the ceramic molding for producing geometrically exacting final bodies such as crown caps, for example, in such a way that the process is significantly speeded up and the layer thickness may be controlled without use of the principle of electrophoresis.

It has been found that the production of ceramic molded bodies may be controlled in a targeted manner with respect to the desired layer thickness, and that glass, various plastics, or metals, for example, may be used as mold materials as an alternative to gypsum or porous plastics when the shaping is performed by contact of the slip with molding paste according to claim 1.

A prerequisite for electrostatic destabilization for induction of controlled coagulation is an electrostatically stabilized slip. The stabilization of the slip may be adjusted in a targeted manner by making use of the zeta potential and the isoelectric point (IEP). For example, aluminum oxides from the Bayer process have a very broad IEP, so that a strictly aqueous slip may be adequately stabilized. Electrostatic stabilization results in a loose configuration in the liquid environment of the slip. By modifying the force of repulsion (modification of the charge diffusion of the ion shell of a ceramic particle, electrostatic destabilization), the loose configuration in the liquid environment may be eliminated and a targeted compacting of the ceramic powder contained in the slip may be achieved.

In one embodiment, the invention therefore relates to a molding paste for use in ceramic molding, containing
at least one release agent and
at least one ion-donating agent and/or an amphoteric substance.

The paste preferably represents an electrostatically destabilizing composition.

The release agent preferably belongs to the group composed of cremes, gels, salves, or cleansers. The ion-donating agent preferably is a water-soluble salt, particularly preferably from the group composed of alkali, ammonium, or alkali earth halides. The amphoteric substance preferably is a detergent such as SDS or Tween, for example. An aqueous solvent and an emulsifier may also be present. The salt is present in the composition in a concentration, for example, of 3-80% by weight, preferably 5-70% by weight, particularly preferably 7-60% by weight.

The invention further relates to the use of a molding paste described above for producing ceramic bodies from a ceramic slip, in particular for producing parts of dental prostheses.

The invention further relates to a method for producing ceramic bodies from a ceramic slip, in which
A a molding paste containing
   at least one release agent and
   at least one ion-donating agent and/or an amphoteric substance is applied to a surface of a model,
B the molding paste is then brought into contact with the ceramic slip,
C the body is formed by compacting at least a portion of the ceramic slip to the molding paste, and
D is then removed from the model.

Surprisingly, it has been shown that such a method may be extended to additional fields of application for ceramics besides the field of dental technology. By means of this method it is possible by use of a molding paste to produce ceramic molded bodies, regardless of the type of mold, that may also be easily removed from the mold.

Thus, under the stated prerequisites, components may be produced from slips by targeted molding by the principle of electrostatic destabilization.

The invention therefore further relates to the use of commercially available formulations such as cremes, gels, salves, or cleansers as molding pastes, which either already have sufficiently high salt or electrolyte contents or which may be subsequently provided with a salt.

Of course, corresponding pastes may also be produced by mixing the components.

The invention further relates to a method for destabilizing electrostatically stabilized slips by impregnating the surface of the model to be coated, using a molding paste containing

a paste base and

soluble inorganic or organic salts, preferably alkali and alkali earth halides or inorganic or organic ammonium salts.

In addition, a suitable layer is formed by any other soluble compounds that modify the ion shell of the particle. For example, a metal salt such as CoSO₄ or ionic surface-active substances may also be used.

Without limiting the invention, the effect is explained as follows:

The ions present go into solution upon contact with slip, and reduce the charge diffusion in the ion shell of the ceramic particles. This causes the particles to become more closely packed and interlocked to form a more compact layer which is mechanically stable. The time required for forming the layer may be controlled by the salt content of the paste. If the paste also has a fat-based formulation, this further facilitates removal or release of the formed mold from the model. Layers may thus be produced on free molds in a targeted manner. Subsequent drying produces porous layers which may be sintered.

In one comprehensive study it was demonstrated that the solubility of the salt plays a crucial role. For the compacting for molding, the ions in the slip must be available, or must come into contact with the particles at least at the boundary layer of the molding paste, to enable the diffuse electrical double layer to be modified. This is corroborated by studies using salts of differing solubilities.

### EXAMPLE 1

Molding Paste Based on Commercially Available Cosmetic or Medicinal Emulsions, Gels, and Cremes

A commercially available skin creme, for example Tactosan (water/oil emulsion, Stockhausen Hautschutz [skin care]), was heated to the melting point, then an aqueous 60% magnesium chloride solution was stirred in and the entire mixture was homogenized with stirring. After cooling, the mixture had a paste-like consistency and was ready for molding. The concentration of the magnesium chloride solution may optionally be varied between 3 and 80% by weight. As an alternative to a water/oil emulsion, a medicinal electrode creme may also be used which, according to its application, already contains a salt, such as an electrode creme (Marquette Hellige) containing 5% by weight NaCl.

### EXAMPLE 2

Molding Pastes Containing Individual Components

Vaseline-Based

| | |
|---|---|
| 5 g | Vaseline |
| 1 g | cetyl palmitate |
| 2 g | ammonium acetate |
| 1 g | Tween 20 |
| 1 g | water |

and

Paraffin-Based

| | |
|---|---|
| 7 g | liquid paraffin |
| 1.5 g | water |
| 3.2 g | Tween 20 |
| 1 g | CaCl₂ |

were produced by thorough mixing of the components.
Exemplary Embodiment of the Method:

A thin layer of paste according to Example 1 or 2 was brushed onto the mold to be coated. The mold was immersed in a slip for 1 to 10 minutes, depending on the desired layer thickness and the salt content of the paste. The higher the salt content, the more rapid the deposition. For a salt solution of 60% MgCl₂ according to Example 1, after 2 minutes a layer thickness of approximately 670 μm was obtained. At the end of the immersion period the mold was removed from the slip and briefly dried in an air stream at 25-60° C., after which it could be lifted from the mold and then sintered at 1120° C.

1. Molding paste for use in ceramic molding, containing
at least one release agent and
at least one ion-donating agent and/or an amphoteric substance.

2. Electrostatically destabilizing composition according to claim 1.

3. Composition according to claim 1 or 2, wherein the release agent belongs to the group composed of cremes, gels, salves, or cleansers.

4. Composition according to one of the preceding claims, wherein the ion-donating agent is a water-soluble salt.

5. Composition according to one of the preceding claims, wherein the amphoteric substance is a detergent.

6. Composition according to one of the preceding claims, characterized in that the composition also contains an aqueous solvent and an emulsifier.

7. Composition according to claim 3, characterized in that the salt belongs to the group composed of alkali, ammonium, or alkali earth halides.

8. Composition according to claim 3 or 6, characterized in that the salt is present in the composition in a concentration of 3-80% by weight.

9. Composition according to claim 7, characterized in that the salt is present in the composition in a concentration of 5-70% by weight.

10. Composition according to claim 8, characterized in that the salt is present in the composition in a concentration of 7-60% by weight.

11. Use of a molding paste according to one of the preceding claims for producing ceramic bodies from a ceramic slip.

12. Use according to claim 10 for producing part of a dental prosthesis.

13. Method for producing ceramic bodies from a ceramic slip, in which
A a molding paste according to claim 1 is applied to a surface of a model,
B the molding paste is then brought into contact with the ceramic slip,
C the body is formed by compacting at least a portion of the ceramic slip to the molding paste, and
D is then removed from the model.
